(19) United States
(12) Patent Application Publication
(10) Pub. No.: US 2018/0001263 A1
(43) Pub. Date: Jan. 4, 2018

(54) SUBMERGED HYPERFILTRATION SYSTEM

(71) Applicant: Dow Global Technologies LLC, Midland, MI (US)

(72) Inventors: Jon E. JOHNSON, Plymouth, MN (US); Steven D. JONS, Eden Prairie, MN (US)

(21) Appl. No.: 15/540,499

(22) PCT Filed: Jan. 20, 2016
(86) PCT No.: PCT/US2016/013986

§ 371 Date: Jun. 28, 2017

Related U.S. Application Data
(60) Provisional application No. 62/114,609, filed on Feb. 11, 2015.

(51) Int. Cl. B01D 61/02; B01D 61/04; B01D 61/08

(52) U.S. Cl. CPC B01D 61/025; B01D 61/08; B01D 61/04; B01D 2311/2649; B01D 2311/04

(57) ABSTRACT

A submerged water purification system including a plurality of spiral wound hyperfiltration membrane modules each connected in a parallel flow arrangement to a common feed manifold and a common permeate manifold; wherein each module includes at least one feed spacer sheet and one membrane envelop wound about a permeate collection tube having a plurality of openings along its length that are in fluid communication with the membrane envelop, and further including an end cap secured to an end of the module with a manifold junction reversibly connected to the end cap of each module, wherein the manifold junction provides a sealed fluid communication between the feed spacer sheets and permeate collection tubes of each module to the feed manifold and permeate manifold, respectively.

### FIELD

The invention is directed toward underwater hyperfiltration systems.

### INTRODUCTION

There have been several proposals to operate reverse osmosis modules underwater. See for example: U.S. Pat. No. 7,600,567, U.S. Pat. No. 5,366,635, U.S. Pat. No. 3,456,802, US20070151916, US20100237016 and GB2068774. With submerged systems, the hydrostatic head pressure associated with submersion provides a major component of the energy required to overcome osmotic pressure for “reverse osmosis” separation. In the case the system is used to produce permeate for off-shore applications, (e.g. enhanced oil recovery) locating the reverse osmosis system in the sea rather than on a ship or platform also reduces the foot print required for off shore water purification. Another advantage of submerged systems is that bio-growth is less active at greater depths due to reduced light and lower water temperatures. However, because of their depth submerged systems are more difficult to maintain, clean, descale and service. To limit these operating issues, more extensive pretreatment can be used, but at both increased cost and complexity of the system.

### SUMMARY

The invention includes a water purification system including a plurality of spiral wound hyperfiltration membrane modules each connected in a parallel flow arrangement to a common feed manifold and a common permeate manifold. Each module includes at least one feed spacer sheet and one membrane envelop wound about a permeate collection tube having a plurality of openings along its length that are in fluid communication with the membrane envelop, and further includes an end cap secured to an end of the module. A manifold junction is reversibly connected to the end cap of each module and provides a sealed fluid communication between the feed spacer sheets and permeate collection tubes of each module to the feed manifold and permeate manifold, respectively. The modules and manifolds are submerged under water. The system further includes a first pump in fluid communication with the feed manifold and adapted to drive feed flow (sea water) through the feed spacer sheets of each module and a second pump in fluid communication with the permeate manifold and adapted to withdraw permeate from the permeate collection tube of each module. The pumps may be located above or below water. Methods for operating the system that avoid fouling are also described.

### BRIEF DESCRIPTION OF THE DRAWINGS

The figures are not to scale and include idealized views to facilitate description. Where possible, like numerals have been used throughout the figures and written description to designate the same or similar features.

FIG. 1 is a perspective, partially cut-away view of a spiral wound module.

FIGS. 2a and b are schematic views illustrating embodiments of the invention.

FIG. 3 is a perspective view of the embodiment of FIG. 2b.

FIG. 4 is an enlarged exploded view of a module and end cap in partial assembly with a manifold junction.

FIG. 5 is a schematic view of another embodiment of the invention including a pretreatment filter assembly.

### DETAILED DESCRIPTION

The present invention includes a plurality of spiral wound modules (“elements”) suitable for use in reverse osmosis (RO) and nanofiltration (NF). RO membranes used to form envelops are relatively impermeable to virtually all dissolved salts and typically reject more than about 95% of salts having monovalent ions such as sodium chloride. RO membranes also typically reject more than about 95% of inorganic molecules as well as organic molecules with molecular weights greater than approximately 100 Daltons. NF membranes are more permeable than RO membranes and typically reject less than about 95% of salts having monovalent ions while rejecting more than about 50% (and often more than 90%) of salts having divalent ions—depending upon the species of divalent ion. NF membranes also typically reject particles in the nanometer range as well as organic molecules having molecular weights greater than approximately 200 to 500 Daltons. For purposes of this description, the term “hyperfiltration” encompasses both reverse osmosis (RO) and nanofiltration (NF).

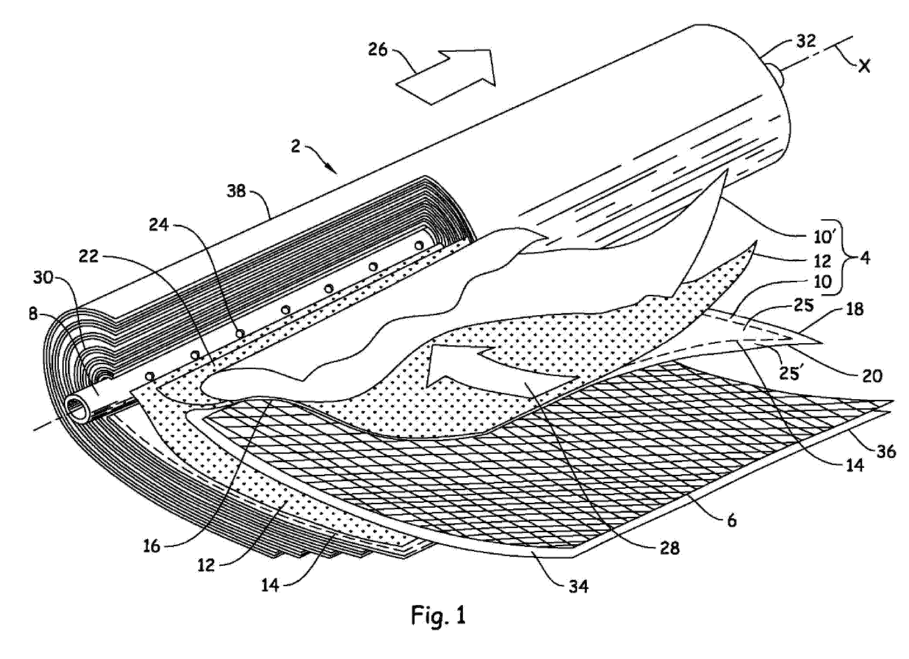

A representative spiral wound filtration module is generally shown in FIG. 1. The module (2) is formed by concentrically winding one or more membrane envelopes (4) and feed spacer sheet(s) (“feed spacers”) (6) about a permeate collection tube (8). Each membrane envelope (4) preferably comprises two substantially rectangular sections of membrane sheet (10, 10′). Each section of membrane sheet (10, 10′) has a membrane or front side (34) and support or back side (36). The membrane envelope (4) is formed by overlaying membrane sheets (10, 10′) and aligning their edges. In a preferred embodiment, the sections (10, 10′) of membrane sheet surround an optional permeate channel spacer sheet (“permeate spacer”) (12) to form permeate channels (12′) between membrane back surfaces (36). This sandwich-type structure is secured together, e.g. by sealant (14), along three edges (16, 18, 20) to form an envelope (4) while a fourth edge, i.e. “proximal edge” (22) abuts the permeate collection tube (8) so that the inside portion of the envelope (4) (and optional permeate spacer (12)) is in fluid communication with a plurality of openings (24) extending along the length of the permeate collection tube (8). The module (2) preferably comprises a plurality of membrane envelopes (4) separated by a plurality of feed spacers sheets (6). In the illustrated embodiment, membrane envelopes (4) are formed by joining the back side (36) surfaces of adjacently positioned membrane leaf packets. A membrane leaf packet comprises a substantially rectangular membrane sheet (10) folded upon itself to define two membrane “leaves” wherein the front sides (34) of each leaf are facing each other and the fold is axially aligned with the proximal edge (22) of the membrane envelope (4), i.e. parallel with the permeate collection tube (8). A feed spacer sheet (6) is shown located between facing front sides (34) of the folded membrane sheet (10). Voids in the feed spacer sheet (6) create a feed channel (6′) through which feed fluid flows. Feed flow is illustrated in an axial direction (i.e. parallel with the permeate collection tube (8)) through the module (2). While not shown, additional intermediate layers may also be included in the assembly. Representative examples of membrane leaf packets and their fabrication are further described in U.S. Pat. No. 7,875,177.

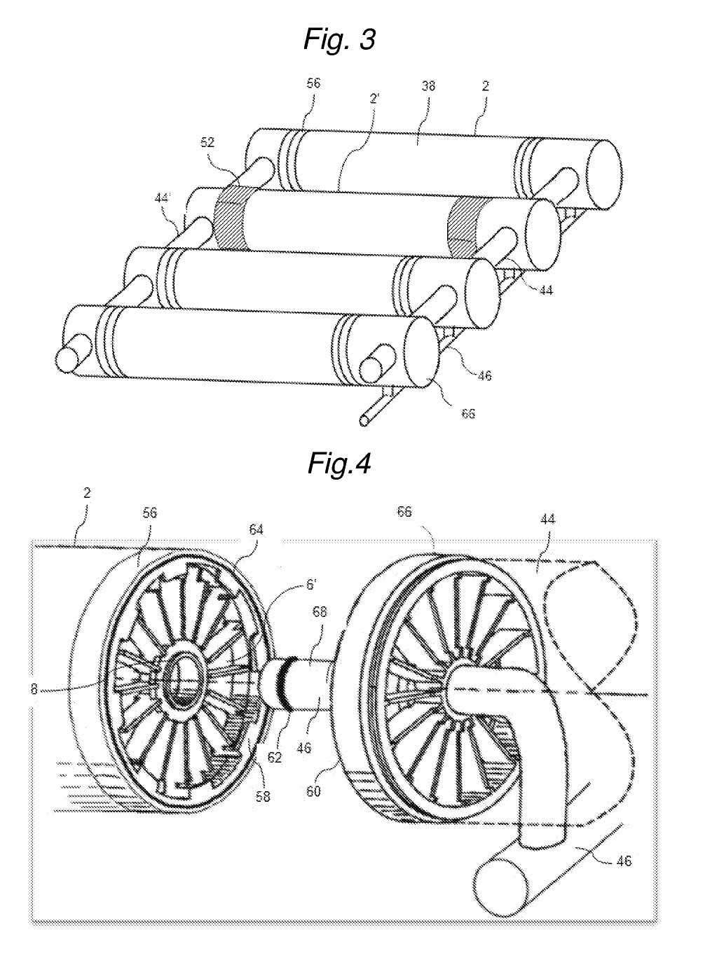

During module fabrication, permeate spacer sheets (12) may be attached about the circumference of the permeate collection tube (8) with membrane leaf packets interleaved there between. The back sides (36) of adjacently positioned membrane leaves (10, 10′) are sealed about portions of their periphery (16, 18, 20) to enclose the permeate spacer sheet (12) to form a membrane envelope (4). Suitable techniques for attaching the permeate spacer sheet to the permeate collection tube are described in U.S. Pat. No. 553,862. The membrane envelope(s) (4) and feed spacer(s) (6) are wound or “rolled” concentrically about the permeate collection tube (8) to form two opposing scroll faces at opposing ends (30, 32) and the resulting spiral bundle is held in place, such as by tape or other means. The scroll faces may then be trimmed and a sealant may optionally be applied at the junction between the scroll faces and permeate collection tube (8) as described in U.S. Pat. No. 7,951,295. Modules of the present invention preferably include a non-porous cylindrical shell (38) that is integral with the module. Long glass fibers may be wound about the partially constructed module and resin (e.g. liquid epoxy) applied and hardened. In some applications, it may be sufficient to apply tape about the circumference of the wound module, as described in U.S. Pat. No. 812,588. A non-porous shell (38) may also be applied by other methods (e.g. wrapping hot melt, injection molding, or use of shrink tubing). At least one end and preferably both ends of module are fitted with an anti-telescoping device or “end cap” (56) (shown in FIG. 4) designed to prevent membrane envelopes from shifting under the pressure differential between the inlet and outlet scroll ends of the module. Representative examples are described in: U.S. Pat. No. 5,851,356, U.S. Pat. No. 6,224,767, U.S. Pat. No. 7,063,789 and U.S. Pat. No. 7,198,719.

Materials for constructing various components of spiral wound modules are well known in the art. Suitable sealants for sealing membrane envelopes include urethanes, epoxies, silicones, acrylates, hot melt adhesives and UV curable adhesives. While less common, other sealing means may also be used such as application of heat, pressure, ultrasonic welding and tape. Permeate collection tubes (8) are typically made from plastic materials such as acrylonitrile-butadiene-styrene, polyvinyl chloride, polysulfone, poly (phenylene oxide), polystyrene, polypropylene, polyethylene or the like. Tricot polyester materials are commonly used as permeate spacers (12). Additional permeate spacers are described in US 2010/0006504. However, permeate channels (12′) may be formed by any structure that maintains the surfaces of membrane envelope apart. Representative feed spacers (6) include polyethylene, polyester, and polypropylene mesh materials such as those commercially available under the trade name VEXAR™ from Conwed Plastics. Preferred feed spacers (6) are described in U.S. Pat. No. 6,881,336. To assist in submerged operation with minimal pretreatment of natural waters, the feed channel (6′) preferably has a thickness of at least 1 mm, preferably at least 1.5 mm, or even more preferably at least 2 mm.

The membrane sheet (10) is not particularly limited and a wide variety of materials may be used, e.g. cellulose acetate materials, polysulfone, polyether sulfone, polyamides, polyvinylidene fluoride, etc. A preferred membrane sheet includes FilmTec Corporation's FT-30™ type membranes, i.e. a flat sheet composite membrane comprising a backing layer (back side) of a nonwoven backing web (e.g. a non-woven fabric such as polyester fiber fabric available from Awa Paper Company), a middle layer comprising a porous support having a typical thickness of about 25-125 μm and top discriminating layer (front side) comprising a thin film polyamide layer having a thickness typically less than about 1 micron, e.g. from 0.01 micron to 1 micron but more commonly from about 0.01 to 0.1 μm. The backing layer is not particularly limited but preferably comprises a non-woven fabric or fibrous web mat including fibers which may be orientated. Alternatively, a woven fabric such as sail cloth may be used. Representative examples are described in U.S. Pat. No. 214,994, U.S. Pat. No. 4,795,559, U.S. Pat. No. 5,435,957, U.S. Pat. No. 5,919,026, U.S. Pat. No. 6,156,680, US 2008/0295951 and U.S. Pat. No. 7,048,855. The porous support is typically a polymeric material having pore sizes which are of sufficient size to permit essentially unrestricted passage of permeate but not large enough so as to interfere with the bridging over of a thin film polyamide layer formed thereon. For example, the pore size of the support preferably ranges from about 0.001 to 0.5 μm. Non-limiting examples of porous supports include those made of: polysulfone, polyether sulfone, polyimide, polyamide, polyetherimide, polyacrylonitrile, poly(methyl methacrylate), polyethylene, polypropylene, and various halogenated polymers such as polyvinylidene fluoride. The discriminating layer is preferably formed by an interfacial polycondensation reaction between a polyfunctional amine monomer and a polyfunctional acyl halide monomer upon the surface of the microporous polymer layer as described in U.S. Pat. No. 277,344 and U.S. Pat. No. 6,878,278.

The present water filtration system utilizes the hydrostatic head pressure associated with submersion under water to provide a major component of the energy required to overcome osmotic pressure for “reverse osmosis” separation. As a consequence, operating at very low permeate recoveries is economical viable. For instance, the present submerged system may operate with permeate recovery of less than 20% without providing energy to pressurize the remaining 80% of feed water not produced as permeate. In a preferred embodiment, the subject submerged system is operated with a recovery of less than 15%, less than 10%, or even less than 5%. At such low recoveries, the increase in osmotic strength along the length of a hyperfiltration module is much less than traditional non-submerged operation. As a result, the absolute change in net driving pressure along the length of the module is also much less. As a consequence, high permeability modules are preferred in the present invention. In particular, spiral wound hyperfiltration modules that include membrane sheets with average A-values greater than 5 L/m² hr/bar, more preferably greater than 10 L/m² hr/bar, or even greater than 15 L/m² hr/bar, when measured at 35000 ppm NaCl, 20 L/m² hr, and pH 8.2 are preferred. One way to produce modules with this high of water permeability is to treat commercial brackish water reverse osmosis modules (e.g. FilmTec™ XLE) for a prolonged time with chlorine, such as by methods described in U.S. Pat. No. 5,876,602. Membrane sheet also preferably have an average B-value for NaCl of less than 20 L/m² hr (e.g. from 1 and 20 L/m² hr) when measured under the same conditions.

Arrows shown in FIG. 1 represent the approximate flow directions (26, 28) of feed and permeate fluid (also referred to as “product” or “filtrate”) during operation. Feed fluid enters the module (2) from an inlet scroll face (30), flows across the front side(s) (34) of the membrane sheet(s) through feed channels (6′), and exits the module (2) at the opposing outlet scroll face (32). Permeate fluid flows along the permeate spacer sheet (12) or associated channels (12′) in a direction approximately perpendicular to the feed flow as indicated by arrow (28). Actual fluid flow paths can vary with details of construction and operating conditions.

While modules are available in a variety of sizes, one common industrial RO module configuration is available with a standard 8 inch (20.3 cm) diameter and 40 inches (101.6 cm) length. For a typical 8 inch diameter module, 26 to 30 individual membrane envelopes are wound around the permeate collection tube (i.e. for permeate collection tubes having an outer diameter of from about 1.5 to 1.9 inches (3.8 cm-4.8 cm)). Less conventional modules may also be used, including those described in US 2011/023206 and WO 2012/058038.

In conventional RO operations, a plurality of modules is housed in series within a common pressurized vessel. Feed water flows through successive feed channels of modules from one end of the vessel to the opposite end. In the present invention, the modules are not located within a common pressure vessel. Moreover, each module is preferably connected in a parallel manner to a common feed manifold, and pressure vessels are preferably entirely avoided.

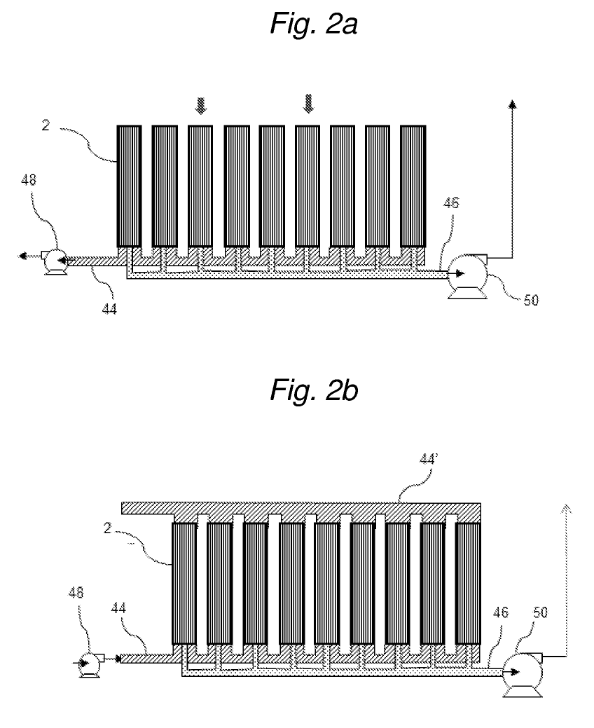

FIGS. 2a and 2b illustrate embodiments of the invention. The water purification system (40) includes a plurality of modules (2), a feed manifold (44), a permeate manifold (46), a first (feed) pump (48) in fluid communication with the feed manifold (44), and a second (permeate) pump (50) in communication with the permeate manifold (46). Arrows generally indicate flow directions associated with various configurations. In a preferred embodiment, the modules (2) are directly connected to the feed and permeate manifolds (44, 46) without a pressure vessel. While not shown, the manifolds (44, 46) and modules (2) may reside within a common enclosure with one or more openings. For example, the enclosure may include netting or a screen material that prevents particulate matter and debris from entering the system. The modules (2) may be connected to either one feed manifold (44) as shown in FIG. 2a, or two opposing feed manifolds (44, 44′) as shown in FIG. 2b. Feed manifolds (44) may be located either upstream (FIG. 2b) or downstream (FIG. 2a) from the modules, and the direction of flow through the manifold may be changed (i.e. reversed) during operation. In a preferable embodiment, the first pump (48) is located downstream from the modules (2), but having a feed pump located upstream of the modules is within scope of the invention (and is illustrated FIG. 2b). Options for manifold design include circular pipes and rectangular ducts of various cross section size and shape, equipped with suitable side-openings or branches to accommodate a plurality of modules. The manifold may be formed from many short sections, each section providing the locking, sealing, or mating structures needed for connection to a single module or a plurality of modules.

FIG. 3 is an enlarged perspective view of the embodiment of FIG. 2b, including a four spiral wound modules (2) connected in parallel and in fluid communication with a downstream (44) and upstream (44′) feed manifold and a permeate manifold (46). In the illustrated embodiment, end caps (56) are provided at both ends of the modules (2). By way of illustration, the end cap (56) may be sealed and secured to the manifolds (44, 46) by way of a compression sleeve (52) or tape that surrounds and presses against the shell (38) of the module.

FIG. 4 is an enlarged view of a preferred end cap (56) including a locking feature (58) that facilitates connecting a hyperfiltration modules (2) to mating features (60) on a manifold junction (66) which is connected to the feed or permeate manifold (44, 46), or both. In the illustrated embodiment, a radial o-ring (62) forms a sliding seal with the permeate tube (8) and an axially compressible o-ring (64) forms a seal between feed channels (6′) and the surrounding water. Similar interlocking designs are described in U.S. Pat. No. 6,632,356 and U.S. Pat. No. 825,773. In a particularly preferred approach, a manifold junction (66) is reversibly connected to an end cap (56) of each module (2). The manifold junction (66) provides a sealed fluid communication between the feed spacer sheets (6) and the feed manifold (44). In a further preferred embodiment best shown in FIG. 4, the manifold junction (66) provides a sealed fluid communication between both the feed spacer sheets (6) and permeate collection tubes (8) of each module (2) to the feed manifold (44) and permeate manifold (46), respectively. As shown, the manifold junction (66) is a single unit that includes a permeate interconnection pipe (68) in sealing engagement and fluid communication with the permeate collection tube (8) and the permeate manifold (46).

In FIG. 4, the permeate manifold (46) includes permeate interconnection pipe (68) for insertion into the permeate tube (8) of the module (2). In other embodiments, modules (2) can be connected to a permeate manifold (46) using a separate interconnector (not shown) that seals to the lateral surfaces (inside or outside) of a permeate tube (8), similar to an approaches taken to connect adjacent modules in series within a vessel. See for example: U.S. Pat. No. 3,928,204, U.S. Pat. No. 4,517,085, U.S. Pat. No. 296,951 and U.S. Pat. No. 5,851,267. Other embodiments include locking structures on the module end caps and on the permeate manifold that force facing sealing surfaces to mate. See for example: U.S. Pat. No. 6,632,356 and U.S. Pat. No. 825,773. In other embodiments, the permeate tube (8) of each of each modules may be blocked at one end such that permeate may only be removed from the opposite end.

As mentioned, the water purification system preferably includes two pumps—a first pump connected to the feed manifold and a second pump connected to the permeate manifold. The first pump preferably operates with a relatively low pressure differential and causes convective flow into the feed manifold and through the feed channels of modules. Preferably, the pump causes a pressure drop of less than 1 bar (ΔP<1 bar). The pump may be a centrifugal-type pump. The second pump connected to the permeate manifold operates with relatively higher pressure difference (ΔP>1 bar) and provides suction to cause permeation through the membrane sheets. It may also serve to raise permeate to the surface. It is noted that a high-pressure pump may be required for driving permeate produced at depth up to the surface. In other cases, permeate may be used for injection in sub-sea formations without being raised to the surface. In one embodiment, multiple pumps are powered from a common motor.

Many bodies of water contain small particles that can foul the membrane or feed channel within a module. As a consequence, feed water is preferably pretreated to remove particular matter prior to being treated by the hyperfiltration modules. Pretreatment is preferably accomplished using a pretreatment filter assembly that is back-washable, so that reversing of fluid flow can effectively remove accumulated particles. In one embodiment, a flow reversal causes a filter to flex or change shape and assist in the removal of accumulated particles and debris from the surface. Examples of such flexible filters include bag or sock type filter and with loosely suspended porous sheet, or a plurality of porous hollow fibers. To limit flow loss in the pretreatment filter, the pretreatment filter assembly preferably has a 90% cutoff greater than 0.01 mm, and even more preferably between 0.02 and 0.2 mm. The pretreatment filter assembly may be an asymmetric sheet, with smaller holes facing the surrounding untreated water and larger holes facing the treated water. Preferably, feed channels of the hyperfiltration modules may have a thickness that exceeds five times, and more preferably ten times, the prefilter's 90% cutoff.

It is preferred that the pump supplying feed flow to the feed manifold and hyperfiltration modules is also used to create flow through the pretreatment filter assembly. The pretreatment filter assembly may be attached to one end of individual hyperfiltration modules. Alternatively it may be connected to an inlet feed manifold so that it pre-treats the water for a plurality of hyperfiltration modules. In some embodiments, an enclosure surrounds the hyperfiltration modules and isolates the modules from particulates in the water body. It is preferred that pressures inside and outside the enclosure can be maintained similar, even within 0.1 bar. The walls of such an enclosure may itself be a permeable material that acts as a pre-filter. Alternatively, the enclosure may be fluidly connected to a pre-filter having high surface area. In a preferred embodiment, the volume of the particulate filtration device exceeds that of downstream hyperfiltration modules.

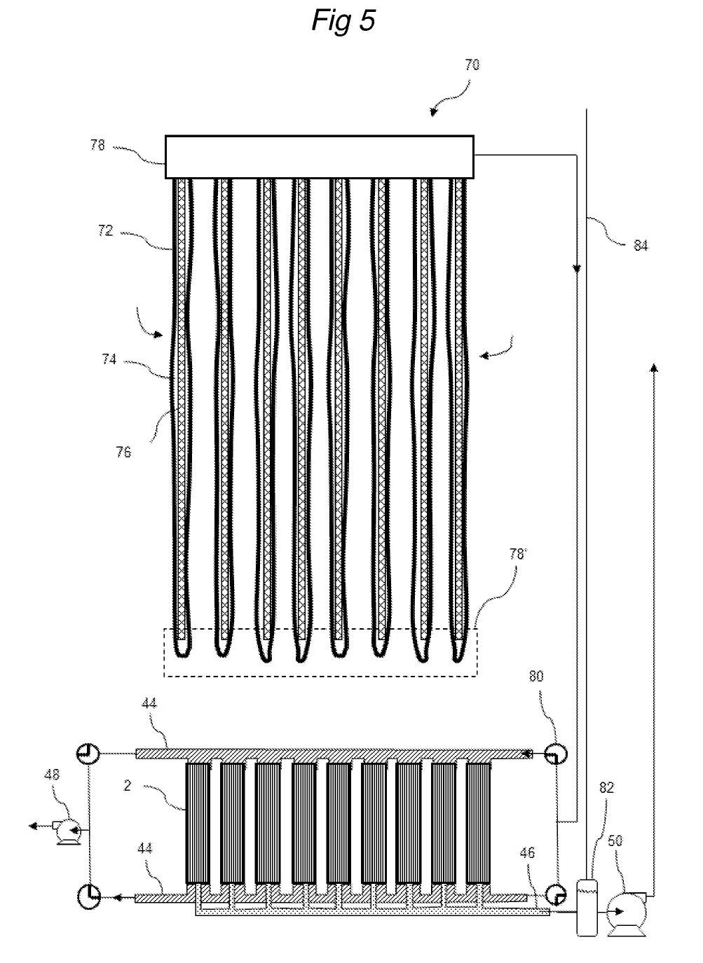

FIG. 5 is a schematic view of another embodiment of the invention including a pretreatment filter assembly (70). In this embodiment, water provided to the hyperfiltration modules is pre-treated by a pretreatment filter assembly (70) including suspended porous sheets (72) through which feed water must pass. The sheets (72) may be weighted or supported to maintain a generally vertical alignment. In one embodiment, two adjacent porous sheets (72) are sealed to form a filtration envelope (74), and a spacer (76) ensures convective transport within the envelope (74). Adjacent porous filtration envelopes (74) may be separated by distances in excess of 10 mm, so that natural currents in the water body assist in removing particulates from between envelopes. First and second headers (78, 78′) may support the envelopes (74). Preferably, parallel sheets are aligned with their plane surface approximately in the direction of a dominant current. In a back-flushing mode, the flexible porous sheets may change shape, potentially contacting other filtration envelopes and sluffing particles therefrom. A large active area of macro-porous sheet can provide a pre-filtration that helps protect the feed channel of hyperfiltration modules from particulate fouling.

Fouling of the feed channels of hyperfiltration modules may also be mitigated by switching the direction of feed flow through the channels. Preferably, the water purification system is sufficient to intermittently allow the direction of flow through the feed manifold and parallel hyperfiltration modules to be reversed. The pump direction may be reversed. Alternatively, opposite flow direction may be accomplished with valves (80) that re-direct feed water. A computer within the system controls the time for switching the flow direction. The system may be operated to provide a greater volumetric flow rate immediately following a flow reversal. A greater flow rate through the feed channels may also be provided in one direction compared to the opposite direction. Preferably, the pump providing flow through the feed channels and feed manifold is also sufficient to allow the direction of flow through a particulate filtration device to reverse. The pump may provide a higher flow rate for back-flushing the particulate filtration device.

The needs of the hyperfiltration modules and pretreatment filter system are different, as the former may require sustained operation at high velocity to loosen and carry away foulants, while the latter may need only short bursts of flow at low velocity to slough particles. In one embodiment, the duration of back-flushing the pretreatment filter is less than the duration of reverse flow through the hyperfiltration modules. For use with short durations, either back-flushing of the particulate filter or reverse flow through the hyperfiltration modules may be performed with raw feed.

Another aspect of this invention is to avoid fouling by operating the hyperfiltration modules at higher cross flow rates than are conventionally used. For instance, module manufacturers' guidelines typically limit the maximum flow rate of concentrate from a system. For an 8-inch diameter Dow module within a shell, the recommended maximum feed flow rate for a system is 17 m³/hr. Normalized to the modules' scroll face area, this corresponds to an average face velocity for feed from the module (immediately downstream of the scroll face) of less than 15 cm/sec. However, in some embodiments, the average face velocity of the concentrate solution immediately downstream of modules in the present invention exceeds, at least intermittently, 20 cm/sec, 25 cm/sec, or even exceeds 30 cm/sec. In one manner of operation, the face velocity exceeds this value during an intermittent cleaning, following a flow reversal.

The embodiments illustrated in FIGS. 2a-b show a single pump (50) located downstream of the hyperfiltration permeate manifold (46). However, FIG. 5 includes also a breathing tube (84) and holding tank (82). It is known that submerged systems may benefit from a breathing tube and holding tank for maintaining consistent pressures (see US201002370). It is within the scope of the invention that the permeate pump may directly create low pressure on the modules (2) to create permeate flow, or it may reduce the pressure of a holding tank (82) and also create permeate flow. In either case, the permeate pump is in fluid contact with the permeate manifold and the modules' permeate tubes. Upon system shutdown, the holding tank (82) may also facilitate osmotic backflow through the membrane for cleaning purposes.

The described water purification system may be applied in several situations. The body of water may be fresh water or saline. The system may be suspended from floats (including a ship), it may be neutrally buoyant, or it may be resting of on a submerged surface (e.g. ocean floor). The depth preferably corresponds to a gauge pressure of at least 200 kPa and less than 8000 kPa, but in other cases it may exceed 10000 kPa. Water may be used for activity below the water's surface (e.g. injection in to formations) or it may be transported to above the surface (e.g. drinking water).

In a preferred embodiment, the water purification system comprises only hyperfiltration modules joined to a common feed manifold in parallel, i.e. none of the modules are arranged in series. However, it is within the scope of the invention for two or more modules to be arranged in series with their feed channels connected. In this case, a seal between the modules must isolate their feed channels from the surrounding water. Another seal may join the two permeate tubes, effectively creating a single, longer module. Swartz describes an applicable embodiment including an inner (permeate) and outer (feed) seal, at least one of which advantageously is a sliding seal. (U.S. Pat. No. 5,851,267)

Many embodiments of the invention have been described and in some instances certain embodiments, selections, ranges, constituents, or other features have been characterized as being “preferred.” Such designations of “preferred” features should in no way be interpreted as an essential or critical aspect of the invention. The entire content of each of the aforementioned patents and patent applications are incorporated herein by reference.

1. A water purification system (40) comprising a plurality of spiral wound hyperfiltration membrane modules (2) each connected in a parallel flow arrangement to a common feed manifold (44) and a common permeate manifold (46);
wherein each module (2) comprises at least one feed spacer sheet (6) and one membrane envelop (4) wound about a permeate collection tube (8) having a plurality of openings (24) along its length that are in fluid communication with the membrane envelop (4) and which are encased within a shell (38) extending along a length between two opposing ends (30, 32), and further including an end cap (56) secured to an end (30) of the module (2);
a manifold junction (66) is reversibly connected to the end cap (56) of each module (2), wherein the manifold junction (66) provides a sealed fluid communication between the feed spacer sheets (6) and permeate collection tubes (8) of each module (2) to the feed manifold (44) and permeate manifold (46), respectively; and
wherein the modules (2) and manifolds (44, 46) are submerged under water; and wherein the system (40) further comprises:
a first pump (48) in fluid communication with the feed manifold (44) and adapted to drive feed flow through the feed spacer sheets (6) of each module (2) and
a second pump (50) in fluid communication with the permeate manifold (46) and adapted to withdraw permeate from permeate collection tube (8) of each module (2).

2. The system (40) of claim 1 wherein the manifold junction (66) includes a permeate interconnection pipe (68) in sealing engagement and fluid communication with the permeate collection tube (8) and the permeate manifold (46).

3. The system (40) of claim 1 wherein the shell (38) of each module (2) is directly exposed to a hydrostatic head pressure associated with the depth of submersion of the system (40)

4. The system (40) of claim 1 wherein the feed spacer sheet (6) has a thickness of at least 1 mm.

5. The system (40) of claim 1 wherein the membrane envelope comprises two membrane sheets each having an average A-value greater than 10 L/m²/hr/bar.

6. The system (40) of claim 1, further comprising a pretreatment filtration system (70) located upstream from the modules, and wherein the first pump (48) is adapted to drive feed flow through the pretreatment filtration system (70) prior to driving the feed through the feed spacer sheets of each module (2).

7. The system (40) of claim 1 wherein the pretreatment filtration system (70) is back-washable.

8. A method for operating the water purification system (40) of claim 1, wherein the modules (2) are operated at a permeate recovery of less than 15%, and where the flow of feed liquid through the modules is intermittently reversed.
